(19) United States
(12) Patent Application Publication
(10) Pub. No.: US 2025/0283512 A1
(43) Pub. Date: Sep. 11, 2025

(54) BEARING DEVICE WITH INTEGRATED ELECTRICAL INSULATION, NOTABLY FOR AN ELECTRIC MOTOR OR MACHINE

(71) Applicant: AKTIEBOLAGET SKF, GOTEBORG (SE)

(72) Inventors: Benoit ARNAULT, Saint-Cyr-sur-Loire (FR); Mickael CHOLLET, Joué-Lès-Tours (FR); Anthony SIMONIN, Tours (FR); Pierre MAGNIER, Luynes (FR)

(21) Appl. No.: 19/068,333

(22) Filed: Mar. 3, 2025

(30) Foreign Application Priority Data
Mar. 11, 2024 (FR) 2402412

(51) Int. Cl. F16C 41/00; F16C 33/58

(52) U.S. Cl. CPC F16C 41/002; F16C 33/583; F16C 2380/26

(57) ABSTRACT

A bearing device includes a bearing having a first ring and a second ring configured to rotate relative to each other relative to a central axis, the second ring having first and second cylindrical surfaces, and a bushing having first and second axial ends and first and second radial surfaces. The bushing is conceptually divided into first and second axial halves by an imaginary plane perpendicular to the central axis and halfway between the first and second axial ends. An electrically insulating insert is overmolded between and connecting the first radial surface of the bushing and the second cylindrical surface of the second ring. The second radial surface of the bushing includes a planar portion extending from the imaginary plane toward the first and second axial ends of the bushing.

### CROSS-REFERENCE

This application claims priority to French patent application no. 2402412 filed on Mar. 11, 2024, the contents of which are fully incorporated herein by reference.

### TECHNOLOGICAL FIELD

The present disclosure relates to the field of bearings that are particularly used in electric motors, electric machines and associated equipment.

### BACKGROUND

In an electric motor or machine, at least one rolling bearing is mounted between the housing of the electric motor or machine and the rotary shaft in order to support this shaft. During operation, when the shaft is rotating, a difference in electric potential can occur between the shaft and the housing of the motor or of the electric machine, generating an electric current between the inner ring of the rolling bearing, which is rigidly connected to the shaft, and the outer ring, which is rigidly connected to the housing. The electric current flowing through the components of the rolling bearing can damage these components, notably the rolling elements and raceways provided on the inner and outer rings. Electrical discharges can also generate vibrations.

In order to overcome these disadvantages, a known solution involves replacing the rolling elements of the bearing, which are made from the same steel as the inner and outer rings, with rolling elements made of ceramic. This is generally referred to as a hybrid rolling bearing. However, such a hybrid rolling bearing is relatively expensive.

In order to overcome the aforementioned disadvantages, another known solution involves equipping the outer ring of the rolling bearing with an insulating sleeve provided with a bushing and an insulating insert made of electrically insulating material and radially interposed between the outer ring and the bushing. In order to attach the insulating insert to the outer ring and to the bushing without any additional elements or specific machining on the outer ring, the insulating insert can be overmolded. However, with such a solution, relative uncoupling of the insulating insert and of the bushing can sometimes occur during operation.

### SUMMARY

Therefore, an aspect of the present disclosure is to overcome the aforementioned disadvantages by providing a bearing device with a simple and economical design.

The disclosure relates to a bearing device comprising a bearing provided with a first ring and a second ring that are able to rotate relative to one another. The device further comprises at least one insulating sleeve mounted on the second ring of the bearing. The insulating sleeve is provided with a bushing and an insulating insert radially interposed between the second ring of the bearing and the bushing. The insulating insert is made of an electrically insulating material.

The bushing comprises an outer surface and an inner surface, opposite the outer surface, which delimit the radial thickness of the bushing. The insulating insert is overmolded onto the second ring of the bearing and at least onto one of the outer and inner surfaces of the bushing. According to a general feature, the surface of the bushing is provided with at least one planar portion, sometimes referred to as a “flat.”

This provides a bearing device with integrated electrical insulation that is economical compared with conventional hybrid rolling bearings. Furthermore, the device is easy to manufacture and assemble into the associated electric motor or machine.

In addition, providing the planar portion on the bushing allows a good connection to be obtained with the insulating insert in so far as a planar portion with a matching shape is formed on the insert during overmolding. The risk of any relative movement between the insulating insert and the bushing in the circumferential direction is particularly limited, notably during temperature variations.

As used herein, “axial direction” is understood to mean the direction parallel to the axis of the bearing device and “circumferential direction” is understood to mean the direction that is perpendicular both to the axial direction and to a radius of the bearing device, in other words, tangent to a circle whose center is on the axis of the bearing device.

In one embodiment, the planar portion comprises a first circumferential edge that circumferentially connects to an end zone of a cylinder portion of the surface of the bushing. The planar portion can also include a second opposite circumferential edge that circumferentially connects to another end zone of the cylinder portion of the surface, or to an end zone of another cylinder portion of the surface.

According to one design, the surface of the bushing is provided with a single cylinder portion and the planar portion that circumferentially connects to the cylinder portion.

According to another design, the surface of the bushing is provided with a plurality of planar portions spaced apart from one another in the circumferential direction, and a plurality of cylinder portions that each extend between two successive planar portions.

According to yet another design, the surface of the bushing is provided with a plurality of planar portions, with at least some or all of the planar portions circumferentially connecting with each other.

The bushing has two front faces delimiting its axial length. According to a first design, the planar portion extends from one of the front faces towards the other front face. The planar portion can extend to the other front face or can remain axially spaced from the other front face.

According to a second design, the planar portion remains at a distance from (is axially spaced from) the front faces.

In a particular embodiment, the bushing is made of metal material. The bushing thus can be easily machined to a predetermined radial tolerance.

In one embodiment, the insulating insert covers the whole of the surface of the bushing. In this case, the insulating insert completely covers the surface of the bushing in the axial direction and in the circumferential direction.

According to a first design, the bushing delimits the outer surface of the device. In this case, the second ring is the outer ring of the bearing. According to a second alternative design, the bushing delimits the inner surface of the device. In this case, the second ring is the inner ring of the bearing.

According to another embodiment, a bearing device includes a bearing including a first ring and a second ring configured to rotate relative to each other relative to a central axis, the second ring having a first cylindrical surface and a second cylindrical surface radially spaced from the first cylindrical surface. The device also includes a bushing having a first axial end and a second axial end and an axial length from the first axial end to the second axial end and also having a first radial surface and a second radial surface radially spaced from the first radial surface of the bushing. The bushing is conceptually divided into a first axial half and a second axial half by an imaginary plane perpendicular to the central axis located halfway between the first axial end and the second axial end, and an electrically insulating insert overmolded between and connecting the first radial surface of the bushing and the second cylindrical surface of the second ring. The second radial surface of the bushing includes a planar portion extending from the imaginary plane toward the first axial end of the bushing and from the imaginary plane toward the second axial end of the bushing.

If the insulating insert is made of synthetic or elastomer material, it makes the device insensitive to temperature variations.

In a particular embodiment, the bearing comprises at least one row of rolling elements disposed between raceways of the first and second rings. The rolling elements can be made of metal material.

The disclosure also relates to an electric motor comprising a housing, a shaft and at least one bearing device as defined above and radially mounted between the housing and the shaft.

### BRIEF DESCRIPTION OF THE DRAWINGS

The present invention will be better understood with reference to the detailed description of an embodiment, which is provided by way of a non-limiting example and is illustrated by the appended drawings, in which:

FIG. 1 is a half-view of an axial section of a bearing device according to one embodiment of the disclosure.

FIG. 2 is a perspective view of a bushing of the bearing device of FIG. 1.

FIG. 3 is a side view of the bushing of FIG. 2.

FIG. 4 is a section view along the IV-IV axis of FIG. 3.

### DETAILED DESCRIPTION

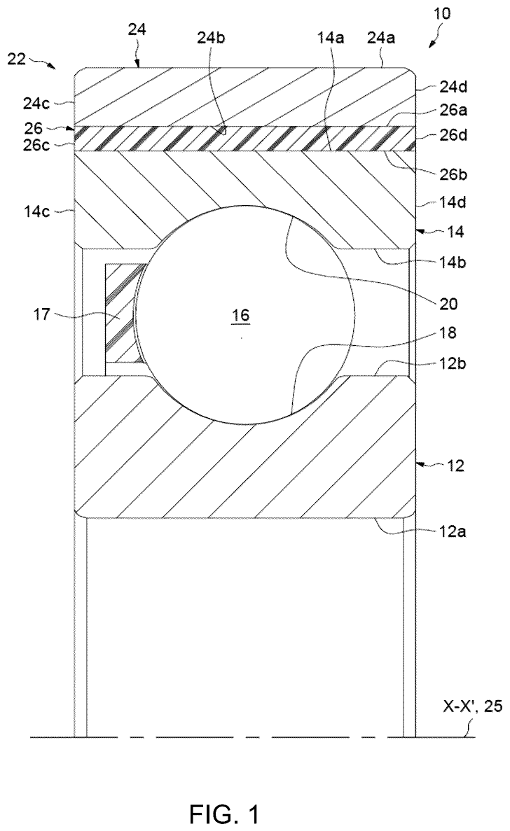

The bearing device illustrated in FIG. 1 comprises a bearing 10 having a first ring 12 and a second ring 14 that are configured to rotate relative to each other about the X-X′ axis of the bearing. In the illustrated embodiment, the first ring 12 is the inner ring of the bearing and the second ring 14 is the outer ring.

As will be described in further detail hereafter, the bearing device is designed so that it does not conduct electric currents. The bearing device has integrated electric insulation.

The inner 12 and outer 14 rings of the bearing are concentric and axially extend along the X-X′ axis of the bearing. The inner 12 and outer 14 rings are made of steel and are solid type rings.

In the illustrated embodiment, the bearing 10 also comprises a row of rolling elements 16, in this case balls, radially interposed between the inner 12 and outer 14 rings. The rolling elements 16 are made of steel. The bearing 10 also comprises a cage 17 for maintaining the even circumferential spacing of the rollers 16. The bearing 10 also can be equipped with sealing seals or flanges.

The inner ring 12 comprises a cylindrical bore 12a, a cylindrical axial outer surface 12b radially opposite the bore, and two opposite radial front faces (not referenced) axially delimiting the bore and the outer surface. The bore 12a and the outer surface 12b delimit the radial thickness of the inner ring 12. The bore 12a forms the inner surface of the inner ring. The inner ring 12 also comprises an inner raceway 18 for the rolling elements 16 that is formed on the outer surface 12b. The raceway 18 is directed radially outwards.

The outer ring 14 comprises a cylindrical axial outer surface 14a, a cylindrical bore 14b radially opposite the outer surface 14a, and two opposite radial front faces 14c, 14d axially delimiting the bore and the outer surface. The outer surface 14a and the bore 14b delimit the radial thickness of the outer ring 14. The outer ring 14 also comprises an outer raceway 20 for the rolling elements 16 that is formed on the bore 14b. The raceway 20 is directed radially inwards.

The bearing device also comprises an electrically insulating sleeve 22 mounted on the outer ring 14. The insulating sleeve 22 is mounted on the outer surface 14a of the outer ring 14. The insulating sleeve 22 is rigidly connected to the outer ring 14.

The insulating sleeve 22 comprises a bushing 24 and an insulating insert 26 radially interposed between the outer ring 14 and the bushing 24. The insulating insert 26 is overmolded onto the outer ring 14 and the bushing 24.

The bushing 24 is annular and extends axially and in the present embodiment is made as a single piece. The bushing 24 comprises a cylindrical axial outer surface 24a, and a cylindrical bore 24b radially opposite the outer surface 24a, the axis 25 of which is coaxial with the X-X′ axis. The bore 24b forms the inner surface of the bushing 24.

The bushing 24 also comprises two opposite radial front faces 24c, 24d axially delimiting the bore and the outer surface. The front faces 24c, 24d delimit the axial length of the bushing. The outer surface 24a and the bore 24b delimit the radial thickness of the bushing 24. The outer surface 24a of the bushing delimits the outer surface of the bearing device 10. In other words, the outer surface 24a defines the outer diameter of the bearing device 10.

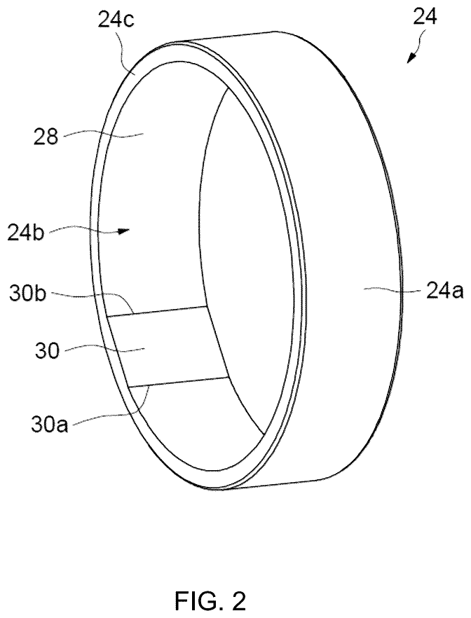

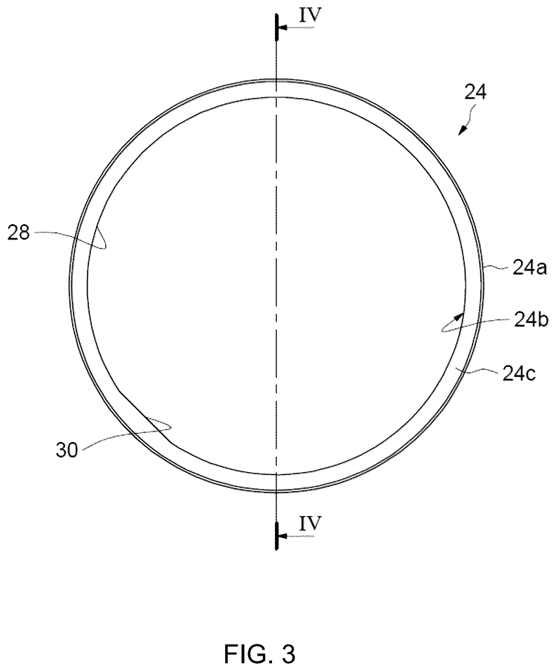

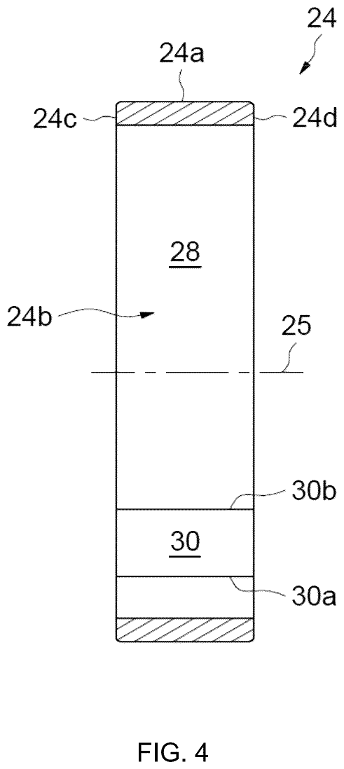

As can be seen in FIGS. 2 to 4, the bore 24b of the bushing is provided with a cylinder portion 28 with an axis 25, and a planar portion 30 that circumferentially connects to the cylinder portion 28. The planar portion 30 projects from the cylinder portion 28. The planar portion 30 has a flat shape.

The planar portion 30 comprises a first circumferential edge 30a that circumferentially connects to an end zone of the cylinder portion 28, and a second opposite circumferential edge 30b in the circumferential direction that circumferentially connects to an opposite end zone of the cylinder portion 28. The planar portion 30 forms an interruption in the slope relative to the cylinder portion 28 in its connection zones with the cylinder portion. The planar portion 30 in this case extends over the entire axial length of the bushing. Therefore, the planar portion 30 extends from the front face 24c to the front face 24d.

In the illustrated embodiment, the planar portion 30 extends in the axial direction. Alternatively, the planar portion 30 could be inclined relative to the axial direction so as to also fulfil a function of axially retaining the insulating insert. Alternatively, the planar portion 30 could be inclined at two angles assuming a convex shape of the diamond type or assuming a shape whose slopes may or may not alternate.

The bushing 24 is advantageously made of metal material. Thus, the outer surface 24a of the bushing can be easily machined to a predetermined tolerance if required. Preferably, the bushing 24 is made of steel. The bushing 24 can be obtained from a metal sheet by cutting, stamping and rolling. In this case, the outer surface 24a of the bushing can have a depression so as to obtain the planar portion on the bore 24b by locally pushing back material. Alternatively, the bushing 24 can be obtained from a tube or from forged/rolled blanks, or even from sintering and stamping.

The insulating insert 26 is made of electrically insulating material. The insulating insert 26 can be made, for example, of synthetic material, such as PEEK or PA46, or it even can be made of elastomer material, such as rubber, for example.

The insulating insert 26 is radially interposed between the outer surface 14a of the outer ring and the bore 24b of the bushing. The insulating insert 26 covers the outer surface 14a of the outer ring. In this case, the insulating insert 26 completely covers the outer surface 14a in the axial and circumferential directions. The insulating insert 26 also covers the bore 24b of the bushing. The insulating insert 26 in this case also completely covers the bore 24b in the axial and circumferential directions. The insulating insert 26 covers the cylinder portion 28 and the planar portion 30 of the bore 24b.

As previously indicated, the insulating insert 26 is overmolded onto the outer ring 14 of the bearing and onto the bushing 24. The insulating insert 26 is overmolded onto the outer surface 14a of the outer ring 14 and onto the bore 24b of the bushing 24.

The insulating insert 26 is annular and extends axially. The insulating insert 26 has an axial outer surface 26a, a cylindrical bore 26b radially opposite the outer surface 26a, and two opposite radial front faces 26c, 26d axially delimiting the bore and the outer surface. The front faces 26c, 26d axially delimit the insulating insert 26. The outer surface 26a and the bore 26b delimit the radial thickness of the insulating insert 26. The outer surface 26a is in radial contact with the bore 24b of the bushing. The bore 26b is in radial contact with the outer surface 14a of the outer ring.

The outer surface 26a of the insulating insert matches the shape of the bore 24b of the bushing and is thus provided with a cylinder portion with a shape that matches the cylinder portion 28 of the bushing, and with a planar portion with a shape that matches the planar portion 30.

In the illustrated embodiment, the faces 14c, 26c, 24c and 14d, 26d, 24d of the outer ring, the insulating insert and the bushing are respectively coplanar.

Alternatively, other arrangements can be provided. For example, the insulating insert 26 could have a limited axial dimension and could remain axially set back from the faces 14c, 14d of the outer ring. Alternatively, the insulating insert 26 could have a greater axial dimension and axially project from the faces 14c, 14d of the outer ring. In this case, the insulating insert 26 can at least partly cover these faces 14c, 14d. As a variant, the insulating insert 26 could at least partly cover the faces 24c, 24d of the bushing.

In another alternative, or in combination, the bushing 24 could axially project from the insulating insert 26 relative to the faces 26c and 26d, or could remain axially set back from these faces.

The bearing device is manufactured as follows.

In a first step, the bearing 10 and the bushing 24 having the planar portion 30 are mounted inside a mold that is provided for overmolding the insulating insert 26. In this position mounted inside the mold, the bushing 24 is radially spaced apart from the outer ring 14 of the bearing.

Then, in a second successive step, the insulating insert 26 is overmolded both onto the outer ring 14 of the bearing and onto the bushing 24.

Finally, the bearing device, which is in the form of a unitary assembly, is removed from the mold.

As previously mentioned, in this embodiment the planar portion 30 of the bore of the bushing extends from the front face 24c to the front face 24d. Alternatively, other arrangements can be provided. For example, the planar portion 30 can be axially spaced from at least one of the front faces 24c, 24d of the bushing or from the two front faces 24c, 24d.

In another variant, the bore 24b of the bushing could be provided with a plurality of planar portions 30 spaced apart from one another in the circumferential direction, with two successive planar portions being separated by a cylinder portion.

In another variant, when the bore 24b of the bushing comprises a plurality of planar portions 30, provision can be made for several successive planar portions to be circumferentially connected to each other, or even for all the planar portions to be circumferentially connected to each other. In the latter case, the bore 24b of the bushing would not have any cylinder portion.

When the bore 24b of the bushing comprises a plurality of planar portions 30, the planar portions can be identical to each other, or, in the alternative, can have different lengths and/or circumferential dimensions, and/or different inclines.

In the illustrated embodiment, the first ring 12 of the bearing is the inner ring and the second ring 14, on which the insulating insert 26 is molded, is the outer ring.

Alternatively, a reverse arrangement can be provided whereby the second ring 14, onto which the insulating insert 26 is molded, is the inner ring. In this case, the insulating sleeve is located in the bore 12a of the inner ring. The insulating insert is then radially interposed between the bore 12a of the inner ring and the outer surface of the bushing. The insulating insert is overmolded onto the inner ring and at least onto the outer surface of the bushing. The outer surface of the bushing is provided with the one or more planar portions. The bore of the bushing delimits the bore of the bearing device.

In the described embodiments, the bearing of the device is provided with a single row of rolling elements. As a variant, the bearing can be provided with several rows of rolling elements. In addition, the rolling bearing can include types of rolling elements other than balls, for example, rollers. In another variant, the bearing can be a slider bearing devoid of rolling elements.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved insulated bearings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A bearing device comprising:
a bearing including a first ring and a second ring configured to rotate relative to each other relative to a central axis, the second ring having a first cylindrical surface and a second cylindrical surface radially spaced from the first cylindrical surface,
a bushing having a first axial end and a second axial end and an axial length from the first axial end to the second axial end and having a first radial surface and a second radial surface radially spaced from the first radial surface of the bushing, the bushing being conceptually divided into a first axial half and a second axial half by an imaginary plane perpendicular to the central axis and halfway between the first axial end and the second axial end, and
an electrically insulating insert overmolded between and connecting the first radial surface of the bushing and the second cylindrical surface of the second ring,
wherein the second radial surface of the bushing includes a planar portion extending from the imaginary plane toward the first axial end of the bushing and from the imaginary plane toward the second axial end of the bushing.

2. The bearing device according to claim 1,
wherein the second radial surface of the bushing includes a cylindrical portion circumferentially adjacent to the planar portion.

3. The bearing device according to claim 1,
wherein the second radial surface of the bushing includes a cylindrical portion extending from a first circumferential end of the planar portion to a second circumferential end of the planar portion.

4. The bearing device according to claim 1,
wherein the bushing is made of metal.

5. The bearing device according to claim 1,
wherein the planar portion is rectangular.

6. An electric motor comprising:
a housing,
a shaft, and
at least one bearing device according to claim 1 radially mounted between the housing and the shaft.

7. The bearing device according to claim 1,
wherein the planar portion extends from the first axial end of the bushing to the second axial end of the bushing.

8. The bearing device according to claim 7,
wherein the second radial surface of the bushing includes a cylindrical portion circumferentially adjacent to the planar portion.

9. The bearing device according to claim 7,
wherein the second radial surface of the bushing includes a cylindrical portion extending from a first circumferential end of the planar portion to a second circumferential end of the planar portion.

10. The bearing device according to claim 7,
wherein the bushing is made of metal.

11. The bearing device according to claim 7,
wherein the planar portion is rectangular.

12. An electric motor comprising:
a housing,
a shaft, and
at least one bearing device according to claim 7 radially mounted between the housing and the shaft.
